(19) United States
(12) Patent Application Publication
(10) Pub. No.: US 2015/0184324 A1
(43) Pub. Date: Jul. 2, 2015

(54) APPARATUS AND METHOD OF REDUCING VIBRATIONS IN A WASHING MACHINE

(71) Applicant: Dongbu Daewoo Electronics Corporation, Seoul (KR)

(72) Inventor: Sang Su MO, Incheon (KR)

(73) Assignee: Dongbu Daewoo Electronics Corporation, Seoul (KR)

(21) Appl. No.: 14/189,358

(22) Filed: Feb. 25, 2014

(30) Foreign Application Priority Data
Dec. 26, 2013 (KR) 10-2013-0163775

(51) Int. Cl. D06F 37/20; D06F 37/30; G05D 19/02; D06F 33/02

(52) U.S. Cl. CPC D06F 37/203; D06F 33/02; D06F 37/304; G05D 19/02; D06F 2202/12; D06F 2204/065; D06F 2222/00

(57) ABSTRACT

The present disclosure relates to an apparatus and a method of reducing vibrations in a washing machine, and particularly, to an apparatus and a method of reducing vibrations in a washing machine that may predict a resonance frequency (or vibration generation region) before operating or driving a motor during a washing process to prevent a resonance phenomenon, thereby reducing noise and vibrations in the washing machine. To this end, the apparatus may include a motor configured to transmit rotational force; a motor driving unit configured to output a motor driving signal controlling an operation of the motor; and a filter configured to remove or reject a frequency or band causing a resonance phenomenon of the washing machine and allow another frequency or band to pass through in the motor driving signal output.

### CROSS-REFERENCE TO RELATED APPLICATIONS

This application is based on and claims priority from Korean Patent Application No. 10-2013-0163775, filed on Dec. 26, 2013, with the Korean Intellectual Property Office, the disclosure of which is incorporated herein in its entirety by reference.

### TECHNICAL FIELD

The present disclosure relates to an apparatus and a method of reducing vibrations in a washing machine, and particularly, to an apparatus and a method of reducing vibrations in a washing machine that may predict a resonance frequency or generation region before driving or operating a motor of the washing machine and prevent a (vibration) resonance phenomenon, thereby reducing noise and vibrations in the washing machine.

### BACKGROUND

In general, a washing machine refers to a mechanical apparatus that cleanly and quickly washes contaminants in and/or on dirty laundry such as clothes or bedclothes using an emulsion of detergent, friction of water flow due to rotational motion, impact with the laundry, and the like.

In accordance with the washing mode or manner, washing machines may be classified into a pulsator type (rotating laundry plate type) washing machine, which uses water currents formed by rotating a rotating disc at the bottom of the tub, an agitator type (rod washing type) washing machine, which washes the laundry by rotating a washing rod or agitator that has a rotating wing at the center of the tub, and a drum type (cylinder type) washing machine, which washes the laundry using a gravitational force that occurs when the drum lifts the laundry and drops it back into the water and detergent by rotating the drum.

The pulsator type washing machine and the agitator type washing machine have excellent cleaning power because the laundry may be washed in a short time, but have drawbacks in that the clothes become tangled. The drum type washing machine resolves the aforementioned drawbacks.

In addition, the drum type washing machine washes the laundry using a force that occurs when the laundry is lifted up by a lifter and then drops back into the water by rotating the drum after the water, detergent, and the laundry are put into the drum. This manner has advantages in that the clothes are hardly damaged because the clothes experience less friction, and a small amount of water may be used because water is needed only in the bottom part of the tub.

That is, the drum washing machine washes the laundry at least in part using frictional force between the laundry and the drum that is rotated by receiving driving power from a motor when the detergent, the water, and the laundry are put into the drum, such that the clothes are hardly damaged, the clothes are not tangled, and there is an effect of washing the laundry by beating and rubbing the laundry.

However, despite the advantages of the small amount of water used and the thorough washing of the laundry (because of the principle that the laundry drops in the drum), the drum type washing machine requires a motor for generating strong driving power in order to rotate the horizontal tub, and therefore, the drum type washing machine consumes a large amount of electric power in comparison with a general type washing machine.

As described above, washing machines wash laundry using various manners, and when washing, rinsing, and spin-drying operations are sequentially performed during a laundry washing process, the operations are performed by the rotational force of the motor of the washing machine.

However, when the number of unique vibrations of the washing machine is similar to the number of vibrations that arise due to driving or operating the motor when the various washing operations are performed, a resonance phenomenon may arise, thereby increasing vibrations and noise in the washing machine.

When the vibrations and the noise of the washing machine increase due to the resonance phenomenon in the related art, the size (magnitude) and direction of the vibrations are measured by various methods to remove the resonance phenomenon. However, this does not prevent the resonance phenomenon.

Accordingly, a method of preventing vibrations and noise from being generated while using a washing machine by preventing a resonance phenomenon (e.g., before the motor of the washing machine is operated or driven) has been demanded.

### SUMMARY

The present disclosure has been made in an effort to provide an apparatus and a method of reducing vibrations in a washing machine, that prevent a (vibration) resonance phenomenon before driving or operating a motor of the washing machine, thereby preventing vibrations and noise from being generated while using the washing machine.

The present disclosure has been made in an effort to provide an apparatus and a method of reducing vibrations in a washing machine, that predict a resonant region (e.g., vibration frequency range) of the washing machine in advance, thereby removing or minimizing a vibration frequency in the resonant region.

One or more exemplary embodiments of the present disclosure provide an apparatus for reducing vibrations in a washing machine, including: a motor configured to transmit rotational force; a motor driving unit configured to output a motor driving signal controlling an operation of the motor; and a filter configured to remove or reject a frequency or band causing a resonance phenomenon (e.g., motor frequency-based vibrations) in the washing machine and allow another frequency or band to pass through in the motor driving signal.

It is useful to find the unique number of vibrations of the washing machine to design a notch filter that rejects frequency or band causing the resonance phenomenon in the washing machine and allow another frequency or band to pass through. To this end, one or more other exemplary embodiments of the present disclosure provide a resonance band measuring apparatus for reducing vibrations in a washing machine, including: a motor driving unit configured to output a motor driving signal controlling an operation of a motor of the washing machine; a vibration detecting sensor configured to measure a magnitude of the vibrations in the washing machine; a frequency detection unit configured to detect a frequency of the motor driving signal (or of the motor); and a controller configured to output a control signal (e.g., a sine wave for driving the motor) to the motor driving unit, receive the frequency of the motor driving signal from the frequency detection unit, receive the magnitude of the vibration from the vibration detecting sensor, and then set a frequency of the motor driving signal. The set (or allowable) frequency or frequencies of the motor driving signal are detected when the magnitude of the vibration exceeds a predetermined value or range. Such detection may be performed for each of the unique number of vibrations of the washing machine.

Yet other exemplary embodiments of the present disclosure provide a resonance band measuring apparatus for reducing vibrations in a washing machine, including: a motor driving unit configured to output a motor driving signal controlling an operation of a motor of the washing machine; a vibration detecting sensor configured to measure a magnitude of vibrations in the washing machine; and a controller configured to output a control signal (e.g., a sine wave for driving the motor for each allowed or detected frequency or band) to the motor driving unit, receive the magnitude of the vibrations from the vibration detecting sensor, and then set a frequency of the control signal for driving the motor. The control signal is output when the magnitude of the vibration at one or more frequencies exceeds a predetermined value or range, and a unique control signal may be output for each unique vibration or vibration frequency of the washing machine.

Still further exemplary embodiments of the present disclosure provide a method of measuring a resonance band for reducing vibrations in a washing machine, including: generating a waveform for driving a motor; converting the waveform for driving the motor into a motor driving signal and outputting the converted motor driving signal to the motor; measuring a magnitude of vibrations in the motor and confirming whether the magnitude of the vibrations exceed a predetermined value or range; and setting a frequency of the waveform for driving the motor or a frequency of the motor driving signal as a resonant frequency causing a resonance phenomenon of the washing machine when the magnitude of the corresponding vibration exceeds the predetermined value or range.

As described above, according to exemplary embodiments of the present disclosure, it is possible to prevent a resonance phenomenon before driving or operating the motor of the washing machine by designing a filter (e.g., a notch filter) capable of removing or minimizing a frequency corresponding to a resonant frequency or region (band) of the washing machine by predicting the resonant frequency or region of the washing machine and applying the filter to the washing machine, thereby preventing vibrations and noise from being generated while using the washing machine.

That is, it is possible to prevent a resonance phenomenon from occurring before operating or driving the motor, without generating the resonance phenomenon first and then removing the resonance phenomenon after its generation (as in the related art), thereby improving user satisfaction with the washing machine.

The number and/or size of vibration reducing devices, such as dampers, coils, springs, weights, etc. for reducing resonance vibrations may decrease, thereby simplifying the structure of the washing machine, and decreasing the costs thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an internal configuration diagram schematically illustrating an exemplary apparatus for reducing vibrations in a washing machine according to the present disclosure.

FIG. 2 is a configuration diagram illustrating an exemplary apparatus for predicting a resonant frequency or region (e.g., band of frequencies) for configuring the exemplary apparatus for reducing vibrations in the washing machine according to the present disclosure.

FIG. 3 is a flowchart illustrating an exemplary method of predicting a resonant frequency or region.

FIG. 4 is an exemplary diagram for describing band rejection using a notch filter.

### DETAILED DESCRIPTION

In the following detailed description, reference is made to the accompanying drawings, which form a part hereof The illustrative embodiments described in the detailed description, drawings, and claims are not meant to be limiting. Other embodiments may be utilized, and other changes may be made, without departing from the spirit or scope of the subject matter presented here.

Hereinafter, exemplary embodiments of the present disclosure will be described in detail with reference the accompanying drawings. A configuration of the present disclosure and an operation and an effect according to the configuration of the present disclosure will be more clearly understood by the detailed description below.

In the following description, the same elements may be designated by the same reference numerals although the elements are illustrated in different drawings, and a detailed explanation of known structures or related constitutions may be omitted so as to avoid unnecessarily obscuring the subject matter of the present disclosure.

FIG. 1 is an internal configuration diagram schematically illustrating an exemplary apparatus for reducing vibrations in a washing machine according to the present disclosure.

Referring to FIG. 1, an apparatus for reducing vibrations in a washing machine may include a motor driving unit 10, a notch filter 12, and a motor 16.

The motor driving unit 10 controls an operation of the motor 16 by outputting a motor driving signal. For example, the motor driving unit 10 may control a rotation speed of the motor 16 (e.g., by adjusting a duty ratio of a pulse width modulation (PWM) signal applied to the motor 16). In one embodiment, the motor driving unit 10 comprises a field effect transistor (e.g., a discrete field effect transistor).

The notch filter 12 is configured to filter (e.g., remove or reject) one or more frequencies or frequency bands of the motor driving signal. The notch filter may comprise a filter through which a specific frequency or frequency band does not pass, and may be referred to as a band rejection filter (BRF) or a band stop filter (BSF). The notch filter 12 may filter more than one frequency or frequency band. Alternatively or additionally, the apparatus for reducing vibrations in a washing machine may comprise more than one notch filter 12.

The notch filter 12 is at an output terminal of the motor driving unit 10 the frequencies or frequency bands corresponding to each unique vibration in or of the washing machine (or, more particularly, the motor) are filtered from the motor driving signal and not output to the motor 16. The notch filter 12 allows other frequencies and/or frequency bands to pass through.

The motor 14 is an apparatus for providing rotational force (e.g., to the drum of the washing machine). The motor 14 rotates in a first direction (e.g., clockwise) or in a second direction (e.g., reversely or counterclockwise) according to the motor driving signal of the motor driving unit 10, and a rotation speed thereof may vary or change. In one exemplary embodiment of the present disclosure, a brushless DC (BLDC) motor is used, but the motor is not limited thereto, and may be or comprise any of various types of motors. The motor 16 generally comprises a plurality of coils (e.g., 3 or 4 coils). In a typical implementation, the coils are identical or substantially identical.

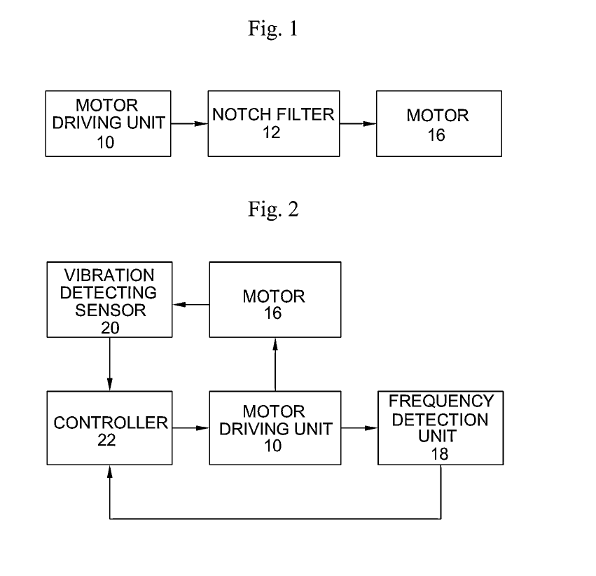

FIG. 2 illustrates an apparatus for predicting a resonant region for configuring the apparatus for reducing vibrations in the washing machine according to the present disclosure.

Referring to FIG. 2, a resonant band measuring apparatus for reducing vibrations in the washing machine includes the motor driving unit 10, the motor 16, a frequency detection unit 18, a vibration detecting sensor 20, and a controller 22.

Constituent elements other than the constituent elements in FIG. 1 will be described.

The frequency detection unit 18 detects a frequency of the motor driving signal output from the motor driving unit 10. The frequency detection unit 18 detects the frequency of the motor driving signal by receiving the motor driving signal or receiving a parameter (or value of the parameter) of the motor driving signal or that is used to generate the motor driving signal.

The vibration detecting sensor 20 measures a magnitude of the vibrations in the washing machine. The vibration detecting sensor 20 may detect a magnitude of a given vibration by detecting a change in a voltage resulting from the vibration, for example using a piezoelectric element (PZT). A voltage value generated in response to the vibration(s) of the motor 16 in the washing machine is output from the vibration detecting sensor 20 to the controller 22.

The controller 22 generally controls operations of the washing machine, and may comprise or be a microcomputer (e.g., a microprocessor plus a memory, generally in a single unit).

The controller 22 according to the present disclosure outputs a control signal (e.g., sign wave for driving the motor) to the motor driving unit 10, receives the frequency of the motor driving signal from the frequency detection unit 18, and receives a magnitude of the vibration(s) from the vibration detecting sensor 20. The controller 22 then sets a given frequency of the motor driving signal as a frequency causing a vibration in the washing machine when the magnitude of the vibration (e.g., from a coil of the motor) exceeds a predetermined value or range.

That is, when the vibration of the washing machine (e.g., from a coil of the motor) exceeds a predetermined magnitude, it is determined that a resonance phenomenon is generated, and in this case, the frequency of the motor driving signal is predicted as a resonant frequency (e.g., causing one of a number of unique vibrations).

The controller 22 generates various motor driving signals corresponding to the operational modes of the washing machine, and outputs the control signal to operate the motor according to the operational or driving mode. According to the present disclosure, the controller 22 outputs a sine wave for driving the motor for each of a plurality of frequencies (e.g., 5-100 different frequencies, in various increments, ideally optimized for each model of washing machine) in order to find the unique vibrations.

Generally, the different frequencies are incremented and/or scanned prior to each use of the washing machine (e.g., after loading the washing machine with laundry), at a rate of one per 100 msec to one per 10-15 sec.

Accordingly, the controller 22 may directly detect the frequency of the motor driving signal when outputting the control for each of a plurality of frequencies, and as a result, the frequency detection unit 18 may be omitted in some exemplary embodiments.

As described above, in one or more other exemplary embodiments, the controller 22 outputs the control signal for each frequency to the motor driving unit 10, receives a magnitude of the vibration from the vibration detecting sensor 20, and sets a frequency of the control signal (e.g., allowed or disallowed frequencies or frequency bands) for driving the motor. The frequency of the control signal is set and/or the control signal is output when the magnitude of the vibration exceeds a predetermined value or range for each of the unique vibrations of the washing machine.

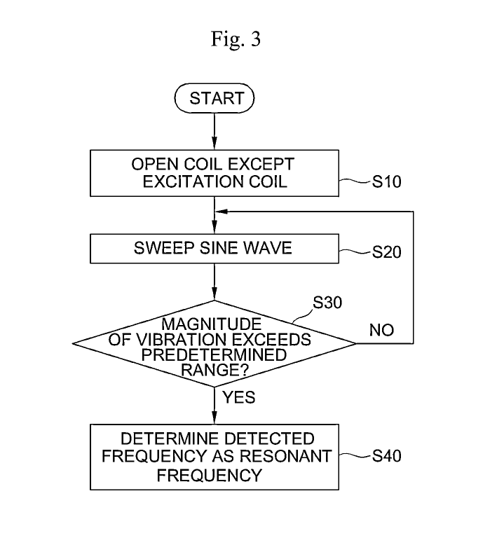

FIG. 3 is a flowchart illustrating a method of predicting a resonant frequency or region (frequency band) for reducing the vibrations in the washing machine.

Referring to FIG. 3, when the BLDC motor is used, coils other than a designated coil (e.g., an excitation coil) to be used in the method are first opened (S10) to prepare for measurement of the resonant frequency or region.

Next, a sine wave sweeping step is performed (S20). The sine wave sweeping step refers to a process of applying a frequency of a sine wave, which is a waveform for driving the motor, while changing the frequency of the sine wave.

The sine wave for driving the motor generated for each frequency through the sine wave sweeping step is converted into a motor driving signal and output to the motor. The motor receives the motor driving signal and rotates in a controlled manner (e.g., at a controlled rate), and any vibration generated during the rotation is detected by the vibration detecting sensor 20.

Next, it is confirmed whether a magnitude of the vibration generated in the washing machine (and more particularly, in the motor or the designated coil of the motor) from the rotation of the motor exceeds a predetermined value or range (S30). When the magnitude of the vibration exceeds the predetermined value or range, the frequency of the sine wave for driving the motor and/or the frequency of the motor driving signal is set as a resonant frequency causing a resonance phenomenon in the washing machine (S40).

When the resonant frequency (e.g., the unique number of vibrations per second) causing the resonance phenomenon in the washing machine is measured, a notch filter is designed or programmed using the resonant frequency.

For example, when the unique number f of vibrations per second is 20 Hz, the notch filter may be designed using Equation 1:

s²+2(ζ₀ω)s+ω²

s²+2(ζ₁ω)s+ω²

[Equation 1]

Here, ω=2×pi×f, and ζ₀ and ζ₁ are values that vary according to an applied frequency range.

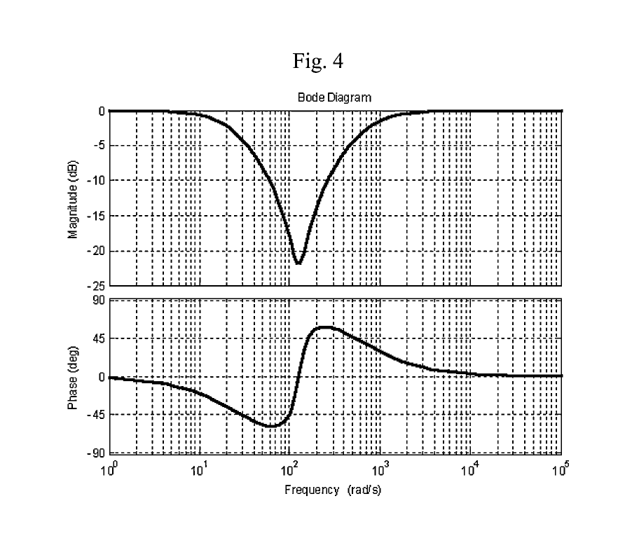

When ω=2×pi×20=125.66, ζ₀=0.2, and ζ₁=2.5 are substituted in Equation 1, a filter function, such as Equation 2 below, is obtained, and when the filter function is graphed or plotted on a bode diagram, the notch filter illustrated in FIG. 4 may be obtained.

$$\frac{{s}^{2} + 50.26 s + {125.66}^{2}}{{s}^{2} + 628.3 s + {125.66}^{2}} \qquad [ Equation 2 ]$$

When the notch filter designed as described above is applied to an output terminal of the motor driving signal, it is possible to remove a frequency or frequency band corresponding to the vibration at a signal level.

The present disclosure may also includes one or more algorithms, computer program(s), tangible or non-transitory computer-readable media and/or software, implementable and/or executable in a general purpose computer or workstation equipped with a conventional digital signal processor, and configured to perform one or more of the methods and/or one or more operations of the hardware disclosed herein. Thus, a further aspect of the invention relates to algorithms and/or software that implement a method for preventing or reducing vibrations in a washing machine, as described herein. For example, the computer program or computer-readable medium generally contains a set of instructions which, when executed by an appropriate processing device (e.g., a signal processing device, such as a microcontroller, microprocessor or DSP device), is configured to perform the above-described method(s), operation(s), and/or algorithm(s).

The computer-readable medium may comprise any medium that can be read by a signal processing device configured to read the medium and execute code stored thereon or therein, such as a CD-ROM or other optical storage, magnetic tape, embedded volatile or non-volatile memory (e.g., embedded flash memory), other flash storage, mask ROM or one-time programmable ROM, hard disk drive, or other physical computer readable media. Such code may comprise object code, source code and/or binary code (e.g., in C, C++, Java, or any other appropriate programming language). The code is generally digital, and is generally configured for processing by a conventional digital data processor (e.g., a microprocessor, microcontroller, or logic circuit such as a programmable gate array, programmable logic circuit/device or application-specific integrated circuit [ASIC]).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An apparatus for reducing vibrations in a washing machine, comprising:
a motor configured to transmit rotational force;
a motor driving unit configured to output a motor driving signal controlling an operation of the motor; and
a filter configured to remove or reject a frequency or band causing a resonance phenomenon in the washing machine and allow another frequency or band to pass through in the motor driving signal.

2. The apparatus of claim 1, wherein the filter receives the motor driving signal from the motor driving unit and provides a filtered motor driving signal to the motor.

3. The apparatus of claim 1, wherein the filter comprises a notch filter.

4. A washing machine, comprising the apparatus of claim 1.

5. A resonance band measuring apparatus for reducing vibrations in a washing machine, comprising:
a motor driving unit configured to output a motor driving signal controlling an operation of a motor of the washing machine;
a vibration detecting sensor configured to measure a magnitude of vibrations in the washing machine;
a frequency detection unit configured to detect a frequency of the motor driving signal; and
a controller configured to output a control signal to the motor driving unit, receive the frequency of the motor driving signal from the frequency detection unit, receive the magnitude of the vibrations from the vibration detecting sensor, and set a frequency of the motor driving signal.

6. The resonance band measuring apparatus of claim 5, wherein the vibration detecting sensor measures the magnitude of vibrations in the motor in response to the control signal being applied to the motor driving unit.

7. The resonance band measuring apparatus of claim 5, wherein the control signal comprises a sine wave for driving the motor.

8. The resonance band measuring apparatus of claim 5, wherein the frequency of the motor driving signal that causes one of the vibrations is detected when the magnitude of the one vibration exceeds a predetermined value or range.

9. The resonance band measuring apparatus of claim 8, wherein the frequency of the motor driving signal that causes one of the vibrations is detected for each of unique vibration of the washing machine.

10. The resonance band measuring apparatus of claim 8, wherein the frequency of the motor driving signal that causes one of the vibrations is detected for each of unique vibration of the motor.

11. A resonance band measuring apparatus for reducing vibrations in a washing machine, comprising:
a motor driving unit configured to output a motor driving signal controlling an operation of a motor of the washing machine;
a vibration detecting sensor configured to measure a magnitude of vibrations in the washing machine; and
a controller configured to output a control signal at each of a plurality of frequencies to the motor driving unit, receive the magnitude of the vibrations from the vibration detecting sensor, and set a frequency of the control signal.

12. The resonance band measuring apparatus of claim 11, wherein the control signal comprises a sine wave for driving the motor.

13. The resonance band measuring apparatus of claim 11, wherein the frequency of the motor driving signal that causes one of the vibrations is output when the magnitude of the one vibration exceeds a predetermined value or range.

14. The resonance band measuring apparatus of claim 11, wherein the frequency of the motor driving signal that causes one of the vibrations is detected for each of unique vibration of the washing machine.

15. A washing machine comprising the resonance band measuring apparatus of claim 11.

16. A method of measuring a resonance band for reducing vibrations in a washing machine, comprising:
generating a waveform for driving a motor;
converting the waveform for driving the motor into a motor driving signal and outputting the converted motor driving signal to the motor;
measuring a magnitude of vibrations in the motor and confirming whether the magnitude of the vibrations exceed a predetermined value or range; and
setting a frequency of the waveform or the motor driving signal as a resonant frequency causing a resonance phenomenon of the washing machine when the magnitude of a corresponding vibration exceeds the predetermined value or range.

17. The method of claim 16, further comprising:
designing or programming a filter configured to remove or reject a band including the resonant frequency and allow another frequency band to pass through.

18. The method of claim 16, wherein generating the waveform includes sequentially generating a sine wave having a voltage and a current for each of a plurality of frequencies.

19. The method of claim 16, wherein the filter comprises a notch filter.

20. A tangible computer-readable medium having a set of instructions encoded therein or thereon, configured to execute the method of claim 16.
